(19) United States
(12) Patent Application Publication
(10) Pub. No.: US 2002/0171685 A1
(43) Pub. Date: Nov. 21, 2002

(54) Using icons to represent physical keys in navigation aids

(76) Inventors: Eric P. Christianson, Meridian, ID (US); Rhonda A. Grindstaff, Boise, ID (US); Michael W. Smith, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/860,182

(22) Filed: May 16, 2001

(51) Int. Cl. G06F 3/14

(52) U.S. Cl. 345/835

(57) ABSTRACT

The use of icons to represent the physical keys of a device such as a facsimile machine, copier, scanner, printer, and the like, displayed as visual cues to enhance the user-friendliness of such a device. Icons corresponding to active physical keys of the device are displayed on a display to visually inform a user of the device operations available to the user. Only those icons corresponding to active physical keys are displayed.

### FIELD OF THE INVENTION

The present invention generally relates to icons and more particularly to the use of icons with display devices to visually represent physical navigation keys and command keys to help a user navigate data displayed on the display of a device and select available operations or commands which a user desires the device to undertake.

### BACKGROUND OF THE INVENTION

Our society has become a visual society. Symbols and pictures are use to express ideas and actions. Symbols and pictures are especially useful where communication may be difficult, such as in multi-lingual applications or situations where there is limited space to adequately express ideas with words. As the business world expands across international boundaries and the prevalence of home computing increases, the use of visual cues will become more important.

The visual presentation of data or information is not new. For example, many computer programs are both text and image based. A visual image appearing on a computer display is associated with a program or a function that the computer may be able to perform. For example, a computer program toolbar provides visual representations of operations available to a user of the program. Icons, or graphical images, are arranged in series on a toolbar, the icons providing visual links or buttons which trigger operational functions. Icons allow a user to perform various functions within a computer program by selecting the icon. The selection of a visual tool or button executes a program or function, allowing the user to carry out a task.

Similarly, visual cues have been integrated with touch-sensitive displays on devices such as high-speed digital copiers and the like. Touch-sensitive displays allow a user to physically select a visual cue by touching a portion of the touch-sensitive display corresponding to the desired visual cue. For example, a large touch-sensitive liquid-crystal display visually displays virtual buttons to express the options available to the user. A user may touch a virtual button displayed on a portion of the touch-sensitive display to choose the desired function. The copier then executes the functions corresponding to the icon or virtual button chosen by the user.

Although visual images and icons have been integrated with computers and touch-sensitive displays, icons are not used with many other display screens. For example, display screens found on many printers, copiers, scanners, and facsimile machines are only capable of displaying text. Typically, the messages or instructions displayed are truncated because the display screens associated with such devices are only capable of displaying limited quantities of text. A typical display usually includes one or two rows of character positions, each row containing between about fifteen to twenty character positions. An example of a typical display 500 of this sort is illustrated in FIG. 5. Each character position 510 is capable of displaying a single character. One of the problems with such a display 500 is that the amount of information which can be communicated is limited by the number of characters which can be displayed in the character positions 510. Another common problem associated with such a limited display 510 is the inability of the user to visually determine what they must do to operate the device because the limited area of the display 500 is too small to provide sufficient instructions and is unable to display graphical images or cues. Furthermore, integration of touch-sensitive displays or computer displays with devices currently using standard character position displays is unlikely due to the prohibitive cost associated with touch-sensitive displays and computer displays.

The differences between the touch-sensitive displays available on high-end, expensive machines and character position displays on the lower-end machines is immense. Therefore, it is desirable to provide a display device and method capable of providing advanced features to the user, including built-in and intuitive visual navigational aids and command cues to facilitate the operation of the more complex features of the devices being used in society and improve the user-friendliness of such devices.

### SUMMARY OF THE INVENTION

The present invention involves the use of icons with display devices. More particularly, the present invention involves the use of icons with display devices to represent instructional aids, navigational aids and command cues corresponding to physical keys, buttons or other operational features of a device available to a user.

Instructional aids, navigational aids and command cues are graphical representations or messages which allow a user of a device to visually ascertain the available functions of that device. The graphical messages typically include both text and icons or graphical images, but it is understood that some graphical messages may consist solely of icons or graphical images. For example, a navigational aid may be an icon or graphical image corresponding to a navigation key on the device, such as an up key. The display of an icon representing the up key would be a navigational aid. Similarly, instructional aids typically describe the steps that a user must take to operate a device. For example, an instructional aid may visually inform the user to press a ‘copy’ key to make a copy. Command cues also graphically prompt a user to perform a function. A command cue may inform the user that they must press an ‘ok’ key to call a number displayed on the device.

In a preferred embodiment of the present invention, a device, such as a facsimile machine, includes at least one display device and a number of physical keys which allow a user to designate or control the operations of the device. For example, the physical keys associated with a facsimile machine may include a standard numeric keypad, navigation keys (such as up and down scroll keys), and a command key (such as a send key). Graphical representations of the physical keys are stored in a memory of the facsimile machine. The graphical representations of active physical keys, or those keys which may be chosen to perform a function, are displayed on the display device. In this manner, a user is informed of the physical keys which may be selected to operate the facsimile machine at any given time.

For example, the facsimile machine may include a list of frequently called numbers in its memory which can be displayed to a user. If the list is too large to be displayed entirely on the display, only a portion of the list is displayed at any one time. The user may scroll through the list using the navigation keys to display those numbers not initially appearing on the display. Therefore, a portion of the list is displayed along with graphical images of the up or down navigation keys, depending upon which way the user may scroll through the list of numbers. Display of the navigational aids (the graphical images of the up and down navigation keys) visually informs the user of the actual physical keys of the facsimile machine available to them. In this manner, the user may glance at the visual display and quickly ascertain the navigation keys or which are available to the user based upon the state of the facsimile machine. Thus, the navigation aids act as visual cues to aid in the operation of the machine.

To further explain the above example, imagine a list of ten frequently called numbers stored within the facsimile machine. Due to the display constraints of the display device, only two of the ten numbers in the list are displayed at any one time. When the list of numbers is first displayed, the top two numbers in the list are displayed. The remaining eight numbers can be displayed by scrolling up or down through the list using the up and down navigation keys. Pressing the up navigation key when the top of the data list is displayed would have no effect on the displayed data because the top two numbers are already displayed. Pressing the down navigation key, however, allows the user to move down the data list, causing the displayed list of data to advance by one position such that the second and third data values are displayed on the display device. Therefore, only icons corresponding to physical keys which are active, are displayed. In this case, the down navigation key icon would appear on the display device with the initial display of data as a navigational aid to instruct the user that the only available navigation key option is selection of the down navigation key. Once the down navigation key is selected by a user the list advances and the first number no longer appears on the list. A user could then advance either up or down in the list, therefore, both the up and down navigation key icons are displayed. Similarly, once the bottom, or last number in the list is displayed on the display device, there is no need to display the down navigation key icon because the down navigation key is no longer active. In other words, if the selection of a navigation key will not perform a machine function, the navigation key is not active and its corresponding graphical image, or icon, is not displayed. Upon reaching that point, the down navigation key icon is removed from the display, leaving only the up navigation key icon as a list navigation option.

Other icons corresponding to additional physical keys may also be displayed on the display device. In the embodiment described above, a command cue could also be displayed. A command key icon corresponding to a physical command key could be displayed as the command cue on the display device. For example, the display of an ‘ok’ command key icon corresponding to a physical ‘ok’ key visually informs the user that they may select the ‘ok’ physical key to perform a function. Thus, the command key icon provides a visual command cue informing the user of the physical command keys available, or active, at any given time.

The present invention uses icons to create and display visual navigational aids, instructional aids, and command cues to a user. Such visual aides and cues increase the user-friendliness of the devices incorporating the present invention. Although not inclusive, the embodiment described demonstrates the present invention. It is understood that the display size may vary and that any number and type of icons may be displayed, alone or in combination with text, to provide visual cues to a user.

### DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1 illustrates a control panel, including a display device capable of displaying icons, which may be found on a device utilizing the present invention;

FIG. 2A illustrates a control panel, including a display device with corresponding region outlines, navigation keys, and command keys, wherein the display device is in a first state utilizing the present invention;

FIG. 2B illustrates the control panel of FIG. 2A wherein the display device is in a second state utilizing the present invention;

FIG. 2C illustrates the control panel of FIG. 2A wherein the display device is in a third state utilizing the present invention;

FIG. 3 illustrates a block diagram of one possible logic sequence for carrying out the embodiments of the present invention;

FIG. 4 illustrates a block diagram of some of the componentry which may be used to carry out the embodiments of the present invention; and

FIG. 5 illustrates a standard character position display as may be found in the prior art.

### DETAILED DESCRIPTION OF THE INVENTION

The present invention involves the use of both graphical and textual instructions with a display device to facilitate navigation and operation of a device which has traditionally used character position displays. The dynamic use of graphical images, such as icons, to provide instructional aids, navigational aides, and command cues to a user creates a user-friendly environment. The graphical representation of the choices available to a user, and the similarity between the graphical representation on the display to the physical key or button that the user may choose, allows the user to correlate operational choices with the physical keys or buttons available to them.

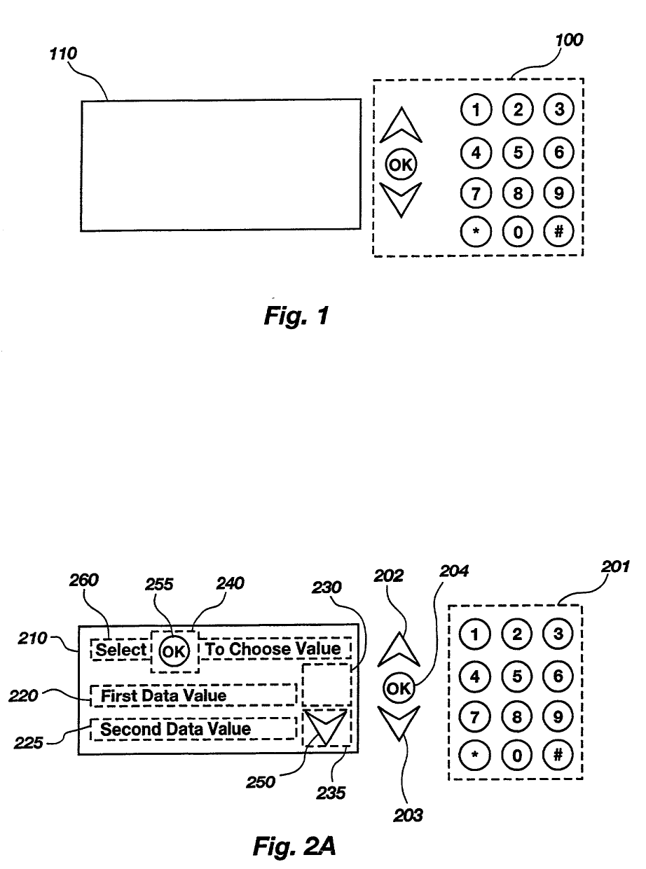

Illustrated in FIG. 1 is a control panel which may be used in the embodiments of the present invention. A plurality of physical keys 100 are arranged with a display 110 to make up the control panel. It is understood that the arrangement illustrated in FIG. 1 is representative only, and that other arrangements are also within the scope of the present invention. The physical keys 100 are associated with various functions of the device (not shown) to which the control panel is attached. A physical key 100 is active if selection of the physical key 100 causes the device to perform a specific operation or function.

The display 110 used with the present invention may be any type of display, including a liquid-crystal display or an active matrix display, so long as the display 110 is capable of displaying both text and graphics. The display 110 may be a color display or a grayscale display. Preferably, the display 110 is a flat panel, bit-mapped display, capable of withstanding the rigors associated with prolonged everyday use.

To carry out the embodiments of the present invention, a control panel similar to that illustrated in FIG. 1 may be integrated with a device which requires input by a user. For example, the present invention may be used with a device such as a facsimile machine, a photo-copier, a scanner, a printer, and the like. Integration of the present invention with a device using a control panel as illustrated in FIG. 1 allows the device to display visual instructional aids, navigational aides, and/or command cues, which facilitate the operation of the device. Such integration provides advantageous operational capabilities over the character position textual displays common in such devices today.

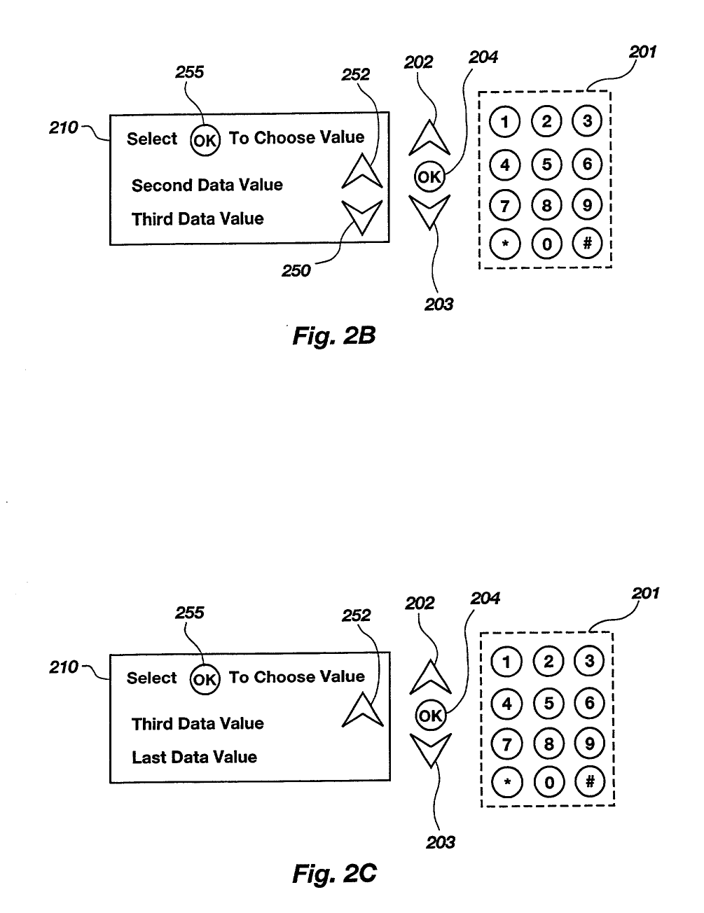

As an example, a facsimile machine (not shown) is equipped with a control panel having a plurality of control keys and a display 210. Illustrated in FIGS. 2A-2C are control keys and a display 210 in various operational states employing the present invention as will be explained herein. The control keys include a standard twelve digit numerical keypad 201, wherein each key of the numerical keypad 201 is associated with a single character or number. Each of the numbers 0 through 9 and the characters “*” and “#” are represented by a single key in the numerical keypad 201 as illustrated. Additionally, the control panel is equipped with a number of physical keys which include a command key 204 and two navigation keys, an up key 202 and a down key 203. The control panel may be equipped with additional physical keys, however, such keys are not illustrated in this example. It is understood that the type, or number of physical keys does not limit the present invention, and that the methods and features of the present invention described herein may be extrapolated to more complicated devices having additional navigational controls, command controls, and physical keys.

The display illustrated in FIGS. 2A-2C is preferably a flat panel, bit-map, display, capable of displaying both graphics and text. The display must also be able to withstand the rigors associated with prolonged everyday use.

The display 210 may be separated into a number of different regions, such as data regions, icon regions, and text regions. Data regions display data, usually text based data, stored in the memory of the device. Similarly, text regions are used to display textual instructions or descriptions. Icon regions, on the other hand, display icons or graphics stored in the memory of the device. The stored icons graphically correspond to the physical keys of the control panel, especially the navigation keys or command keys. The regions may be displayed separately or they may be combined or overlaid in such a manner that an icon region may be joined with a text region or data region to create an instruction or message which includes both text and icons. It is understood that the data regions, icon regions, and text regions may be arranged in any fashion within the display. The data regions, text regions, and icon regions illustrated in FIG. 2A are shown in broken outline for illustrative purposes only. It is understood that although data, text and icon regions exist, the regions are not necessarily visible to the user, only the information displayed in the respective regions is visible. For the purpose of explaining the present invention it is understood that the data, text, and icon regions illustrated in FIG. 2A are also present in FIGS. 2B-2C even though the outline of the regions is not illustrated.

The interaction between a user and the control panel may be better understood with reference to FIGS. 2A-2C. Illustrated in FIG. 2A is a control panel in a hypothetical first state, including display 210 having data, icon, and text regions. A portion of a list of data stored in the facsimile machine's memory is displayed on the display 210. As illustrated in FIG. 2A, the display 210 is capable of displaying two data values on the display 210 at any one time. The two data values are displayed within a first data region 220 and a second data region 225 of the display 210. Once the device determines which data value is the First Data Value, it is displayed in the first data region 220. A Second Data Value, if one exists, is displayed in the second data region 225.

Display 210 also includes a plurality of icon regions for displaying icons. As illustrated in FIG. 2A, a first icon region 230, a second icon region 235, and a third icon region 240 exist. Additional icon regions may also exist depending upon the functions of the display 210 and associated device. Two icons are displayed on the display 210 illustrated in FIG. 2A, an ‘ok’ physical key icon 255 and a down navigation key icon 250. Typically, the icons used with the present invention correspond to physical control keys 200 or navigation keys located on the control panel. The display of icons in the icon regions of the display 210 depends upon the state of the device. As illustrated in FIG. 2A, a down key icon 250 is displayed in the second icon region 235. The down key icon 250 graphically corresponds with the physical down key 203 located on the control panel. Within the third icon region 240, a command key icon 252 graphically corresponding to the command key 204 is displayed. No icons appear in the first icon region 230. Although the icon regions are depicted in fixed or designated locations in the examples described herein, it is understood that they may appear anywhere on the display and may overlay, be overlaid, or be combined with text or data regions.

Instructional text may also be displayed on the display device 210 in a text region 260. The text region 260 illustrated in FIG. 2A is overlaid by the third icon region 240, allowing the instructional text stored in the device to be displayed in conjunction with stored icons. The combination of instructional text with an icon or a plurality of icons provides greater flexibility and communication possibilities between a device and the user. Furthermore, the combination of instructional text with one or more icons provides enhanced visual instructions for the user, making it easier for the user to operate a device utilizing the present invention and thereby enhancing the user-friendliness of the device.

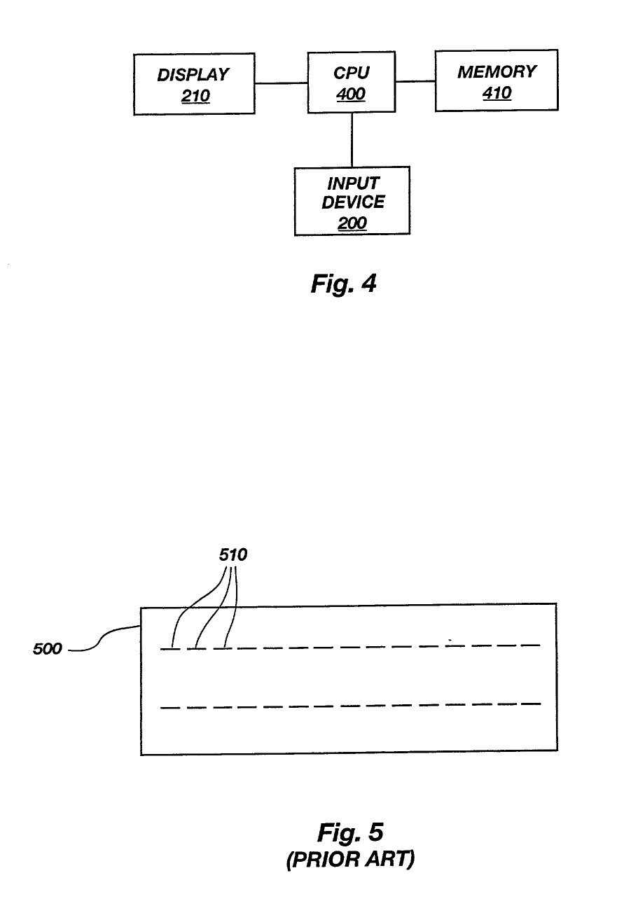

To better understand the present invention, the interaction of a user with the display device 210 and its parent device is explained. FIG. 4 provides a block diagram of the interaction of a display 210 with standard componentry of a device such as a facsimile machine. The central processing unit (CPU) 400 of the device operably communicates with the display 210, an input device 200, and a memory 410. It is understood that more than one display 210, input device 200, memory 410, or other device component, may be in communication with the CPU 400 at any one time as known in the art. For the sake of simplicity, the invention will be described with reference to singular components as illustrated in FIG. 4.

Upon start-up, the CPU 400 operates according to its internal programming, or programming stored in the device memory, and displays any necessary information on the display 210. A user wishing to operate the device does so by using an input device 200, such as a navigation key, or command key. If a navigation key or command key is active, the selection of the active key by the user constitutes a user-executable function. Upon being selected, the active key triggers the CPU 400 to carry out a function programmed in the CPU 400 or the memory 410 of the device. Typically, the CPU 400 provides a user with a start-up menu from which the user may choose the operations which they wish to perform. As an example, assume that a user chooses to access a stored list of frequently dialed numbers from the memory 410 of the facsimile machine and to send a facsimile to a number selected by the user. The CPU 400 responds to the user command to retrieve the list of frequently dialed numbers by clearing or resetting the display 210 so that new information may be retrieved and displayed. FIGS. 2A-2C illustrate the steps of the present invention and the interaction between a user and a device, including commands issued by the CPU 400.

The list of frequently dialed numbers is stored as data in a memory 410 of the facsimile machine. The memory 410 is in communication with the CPU 400. The list of frequently dialed numbers is retrieved by the CPU 400 from the memory 410 and is displayed on the display 210. As data, the frequently dialed numbers are displayed in the data regions of the display 210. As illustrated in FIG. 2A, however, the display 210 in this particular example has only two data regions 220 and 225, so no more than two frequently dialed numbers may be displayed at any one time. It is understood that some displays may be capable of displaying fewer or more data regions than are shown in FIGS. 2A-2C. Assuming that the list of frequently dialed numbers includes four data values, the CPU 400 causes the first frequently dialed number to be displayed in the first data region 220. Since a second frequently dialed number exists, it is displayed in the second data region 225. Because more than two frequently dialed numbers are stored in the memory 410 of the facsimile machine, the user must be given the opportunity to navigate through the data and choose the desired frequently dialed number.

Navigation through the data is accomplished using navigation keys located on the control panel such as navigation keys 202 and 203. The up key 202 and the down key 203 illustrated in FIG. 2A are examples of navigation keys which may be used to navigate through the data. In this example, the data set contains four values, therefore the user must be able to scroll through the additional two values not displayed on the display 210 of FIG. 2A. In prior art displays, the user would have no idea that additional data existed and would be forced to randomly manipulate the physical keys of the device to determine if additional data existed. In the present invention, if additional data exists, the CPU 400 retrieves icons representing the navigational keys from the memory 410 and displays the icons corresponding to active navigation keys in icon regions 230 and 235. The presence of the icons visually informs the user that the corresponding navigation keys may be used to scroll through any additional data which may be stored in the memory 410 of the device. Should the user select a navigation key corresponding to a displayed navigation key icon, the CPU 400 executes a user-executable function associated with the active navigation key. Furthermore, the present invention only displays icons of the navigation keys and control keys which are active. In other words, if one of the navigation keys or control keys has no effect on the operation of the device at a given time, its corresponding icon will not be displayed. In this manner, the user is visually informed at all times of the navigation keys which are active and which will cause the device to perform a navigation function.

For example, in FIG. 2A the data regions 220 and 225 display the First Data Value and the Second Data Value of four data values. There is no data which comes before the First Data Value, so there is no reason to display an icon corresponding to the up key 202 in icon region 230 because selection of the up key 202 would not change the state of the device. However, because there are four data values, selection of the down key 203 would cause the data values to scroll, resulting in the display of the Second Data Value in data region 220 and the Third Data Value in data region 225. Therefore, the down key icon 250 would be displayed in icon region 235 to inform the user that additional data existed and that the user could scroll through the data by selecting or pressing the down key 203 which is graphically represented by the down key icon 250.

Assuming that a user confronted with the display illustrated in FIG. 2A pressed or selected the down key 203, the display 210 illustrated in FIG. 2B would appear. Selection of the down key 203 would cause the data in the data regions to scroll, thereby displaying the Second Data Value in data region 220 and the Third Data Value in data region 225. Likewise, based upon the data displayed in the data regions, the CPU 400 determines that the displayed data could be scrolled either way. In other words, the user could scroll forward to re-display the First Data Value. Selection of the down key 203 when the display 210 is in the state illustrated in FIG. 2A triggers the CPU 400 scroll the data and to display the forward navigation key icon 252 in icon region 230 and the down key icon 250 in icon region 235. The presence of both of the forward navigation key icon 252 and the down key icon 250 visually informs a user that the data displayed in data regions 220 and 225 falls somewhere within the middle of the data list and that the data may be scrolled up or down, and viewed, by pressing either the up key 202 or the down key 203.

Selection of the up key 202 by a user confronted with the display of FIG. 2B would scroll the data up one position such that the display of data and icons as in FIG. 2A would appear on the display 210. Selection of the down key 203, however, would scroll the data down one position and create the display of FIG. 2C. Selecting the down key 203 causes the Third Data Value to be displayed in data region 220 and the Fourth Data Value to be displayed in data region 225. The CPU 400 determines which navigation icons to display. Because the frequently dialed number data list only contains four values, selection of the down key 203 does not scroll any additional data. Therefore, the CPU 400 does not display the down key icon 250 because the down key 203 is no longer active. However, because the user could scroll back to the top of the data list, the up key 202 is active and the forward navigation key icon 252 is displayed in icon region 230 as illustrated in FIG. 2C. In this manner, a user is able to glance at display 210 and know that the only way in which the data may be scrolled is by pressing the up key 202. The user is visually informed of the active navigation keys by the appearance of the corresponding icons within display 210.

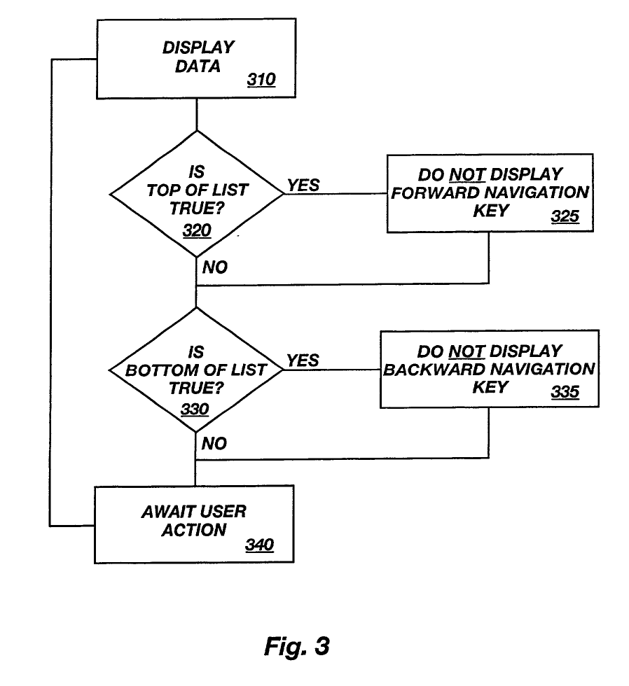

The display of navigation icons on display 210 as in the present invention can be broken down into a representative logic block diagram as illustrated in FIG. 3. It is understood that the block diagram of FIG. 3 represents only one method of determining when to display the navigation icons and that other logic sequences or diagrams could be easily developed to accomplish the same purpose. The variable used in FIG. 3 are defined as follows: the value TopOfList is defined as true when the First Data Value is displayed in data region 220 of FIGS. 2A-2C; the value BottomOfList is defined as true when the Last Data Value is displayed in data region 225 of FIGS. 2A-2C.

Step 310 occurs when the CPU 400 of the device receives a command. During step 310, data is displayed in the data regions and both navigation icons are displayed in icon regions 230 and 235. Step 320 determines if TopOfList is true. If TopOfList is true, the CPU 400 proceeds to step 325 and removes the forward navigation key icon 252 from the display 210 because the selection of the up key 202 would not scroll the data displayed in the data regions. Step 330 then determines if BottomOfList is true. When BottomOfList is true, the CPU 400 executes step 335, removing the down key icon 250 from the display 210. The CPU 400 then awaits a user action 340 before re-displaying data as in step 310. In this manner, the correct navigation icons are displayed on display 210. For example, if the data set displayed by step 310 only contains two data values, the First Data Value is displayed in data region 220 and the Last Data Value is displayed in data region 225. The variable TopOfList is “true” because the First Data Value is displayed in data region 220, and therefore the forward navigation key icon 252 is not displayed. Similarly, BottomOfList is “true” because the Last Data Value is displayed in data region 225. Therefore, the down key icon 250 is not displayed. A user viewing this information would know that the navigation keys were not active and that the only two data values were being displayed.

In addition to displaying navigational icons, the present invention may facilitate the display of command icons to the user as well. Command icons represent the physical keys which may be selected or pressed by the user to execute a command or trigger the device to carry out a particular function. This may include performing a command using data displayed in certain data regions. The use of command icons provides a user with visual confirmation of the necessary steps which must be taken to execute a particular command. For example, a command icon 255 is displayed in icon region 240 in FIGS. 2A-2C. The command icon 255 in this example is an “OK” key icon which corresponds to the physical “OK” key 204 on the control panel. In combination with the text region, the command icon 255 and the corresponding text tell the user that they may select the “OK” button to choose the selected data value displayed in data region 220. For the sake of this example data region 220 is considered the active data region. In other words, if a command function occurs which uses displayed data, the data in data region 220 would be used with the command. Therefore, if a user confronted with the display illustrated in FIG. 2B pressed the “OK” command key 204, the facsimile would dial the number stored in the Second Data Value to send a facsimile. It is understood that the active data region could also be selected or changed using the navigation keys or other keys as desired. Thus, the command icon 255 provides a visual image of the physical key which must be activated to carry out a function. This type of visual command cue has not heretofore been available to users of devices such as facsimile machines, printers, scanners, and copiers, or other devices currently using character position displays.

The display system of the present invention is more advanced and easier to use than those typically found on existing machines. The character positions of existing machines do not have the capability to display icons thus forcing the user to guess as to which navigation, selection, or control keys will execute the desired action. Furthermore, the user may not even know that they have any additional options or data remaining with a character position display. Use of the new display provides an interactive and intuitive display while providing immediately available instructions and visual cues to the user.

Display of the navigation and command icons in the manner described herein provides a user with visual cues such as instructional aids, navigation aids, and command cues which are not available with the character position displays typically associated with devices such as facsimile machines, scanners, copiers, and printers. Providing visual cues such as these to the user enhances the user-friendliness of the device incorporating the present invention and reduces the amount of training required to operate the device.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. A method of improving the user-friendliness of a device having a display and one or more user-executable functions, comprising:
storing graphical images of said user-executable functions;
monitoring said device to determine the user-executable functions available to a user; and
displaying said graphical images of said available user-executable functions on a display to visually inform the user of the user-executable functions available to the user at that time.

2. The method of claim 1, further comprising providing said device with at least one physical key to facilitate the execution of a user-executable function.

3. The method of claim 2, wherein storing graphical images of said user-executable functions comprises storing in a memory of said device a graphical image of said at least one physical key.

4. The method of claim 2, wherein providing said device with at least one physical key to facilitate the execution of a user-executable function comprises providing at least one command key selectable by said user to implement a user-executable function.

5. The method of claim 2, wherein providing said device with at least one physical key to facilitate the execution of a user-executable function comprises providing at least an up key selectable by said user and a down keys electable by said user to facilitate a user-executable selection of data displayed on said device.

6. The method of claim 5, wherein displaying said graphical images of said available user-executable functions on a display comprises displaying said stored graphical image of said up key on said display where an up navigation user-executable function is available to said user.

7. The method of claim 5, wherein displaying said graphical images of said available user-executable functions on a display comprises displaying a stored graphical image of said down key on said display where a down navigation user-executable function is available to said user.

8. The method of claim 5, wherein displaying said graphical images of said available user-executable functions on a display comprises displaying solely a stored graphical image available to said user.

9. The method of claim 1, wherein displaying said graphical images of said available user-executable functions further comprises:
retrieving an icon of said available user-executable functions from a memory of said device; and
displaying said retrieved icon.

10. A method of using icons as visual cues to aid in the operation of a device, comprising:
providing a device having a central processing unit, a display in operable communication with said central processing unit, a memory in operable communication with said central processing unit, and an input device in operable communication with said central processing unit, said input device including at least one physical key;
storing graphical images of said at least one physical key as an icon in said memory of said device;
monitoring said device to determine an available user-executable function stored in said memory of said device or said central processing unit of said device;
determining which at least one physical key corresponds to said available user-executable function; and
displaying said icon of at least one physical key corresponding to said available user-executable function.

11. The method of claim 10, wherein displaying said icon comprises displaying only said icon of at least one physical key available to a user.

12. The method of claim 10, wherein storing graphical images of said at least one physical key as an icon in said memory further comprises storing graphical images of at least one control key and at least one navigation key.

13. The method of claim 12, wherein displaying said icon of at least one physical key further comprises:
displaying a icon corresponding to an active said at least one control key; and
displaying a second icon corresponding to an active said at least one navigation key.

14. A method of improving the user-friendliness of data navigation using a display having a limited area, comprising:
providing a device having a display, a first navigation key, a second navigation key, and a memory;
storing graphical images of said first navigation key and said second navigation key in said memory of said device;
displaying at least one data value of a set of data values on said display, said set of data values having a first data value and a last data value; and
displaying said graphical images of said first navigation key and said second navigation key on said display.

15. The method of claim 14, wherein providing a device having a memory comprises providing a device having a read-only memory wherein said graphical images of said first navigation key and said second navigation key are stored.

16. The method of claim 14, wherein storing graphical images of said first navigation key and said second navigation key in said memory of said device comprises storing icons of said first navigation key and said second navigation key in said memory.

17. The method of claim 14, wherein displaying said graphical images of said first navigation key and said second navigation key on said display further comprises:
displaying said graphical images of said first navigation key if said first data value is displayed and said last data value is not displayed;
displaying said graphical images of said second navigation key if said last data value is displayed and said first data value is not displayed; and
displaying said graphical images of said first navigation key and said second navigation key if neither said first data value nor said last data value are displayed.

18. The method of claim 14, further comprising:
providing a display having at least a first data region and a second data region, said first data region an active data region;
providing at least one command key in addition to said first navigation key and said second navigation key;
storing a graphical images of said at least one command key in said memory of said device;
displaying a data value of said set of data values in said first data region;
displaying a data value of said set of data values in said second data region if more than one data value exists in said set of data values;
displaying said graphical images of said at least one command key if a user-executable function can be performed on said data value displayed in said active data region;
displaying said graphical images of said first navigation key and said second navigation key;
removing said graphical image of said first navigation key from said display if said data value displayed in said first data region is said last data value; and
removing said graphical image of said second navigation key from said display if said data value displayed in said first data region is said first data value.

19. The method of claim 14, further comprising:
providing a plurality of control keys with said device;
storing a graphical image of each of said plurality of control keys in said memory of said device;
determining if any of said plurality of control keys are active; and
displaying said graphical image of each of said active plurality of control keys on said display of said device.

20. The method of claim 19, further comprising:
retrieving a text message corresponding to each of said active plurality of control keys from said memory of said device; and
displaying said graphical image of each of said active plurality of control keys in combination with said text message corresponding to each of said active plurality of control keys.

21. A display system, comprising:
a display device;
at least one navigation key;
a central processing unit in communication with said display device;
a memory in communication with said central processing unit;
a graphical image of said at least one navigation key for storing in said memory;
a first executable function for storing in said memory to determine if said at least one navigation key is active; and
a second executable function for storing in said memory to retrieve said graphical image of an active said at least one navigation key and display said graphical image of said at least one navigation key on said display device.

22. The display system of claim 21, further comprising:
at least one numerical key corresponding to a unique number;
a number image of said at least one numerical key for storing in said memory; and
a third executable function for storing in said memory to detect selection of said at least one numerical key corresponding to a unique number and display said number image of said at least one numerical key on said display device.

23. The display system of claim 22, wherein said number image of said at least one numerical key for storing in said memory is a text image.

24. The display system of claim 22, wherein said number image of said at least one numerical key for storing in said memory is a graphical image.

25. The display system of claim 21, further comprising:
at least one command key;
a command key image of said at least one command key for storing in said memory; and
a command executable function for storing in said memory for detecting selection of said at least one command key and display said command key image of said at least one command key on said display device.

26. A printer display device, comprising:
a bit map display;
a memory;
at least one navigation key;
at least one command key;
at least one graphical image stored in said memory;
a central processing unit in communication with said bit map display and said memory to retrieve said at least one graphical image for storing in said memory and display said at least one graphical image on said bit map display; and
an executable function for prompting said central processing unit for retrieving said at least one graphical image and displaying said at least one graphical image on said bit map display.

27. The printer display device of claim 26, wherein said at least one graphical image for storing in said memory further comprises:
at least one navigation key image, corresponding to said at least one navigation key; and
at least one command key image, corresponding to said at least one command key.

28. The printer display device of claim 26, wherein said executable function further comprises:
a first executable function for determining if said at least one navigation key is active;
a second executable function for determining if said at least one command key is active; and
a third executable function for retrieving and displaying said at least one graphical image for each active said at least one navigation key and each active said at least one command key.

29. The printer display device of claim 26, further comprising:
text data stored in said memory;
a text executable function for retrieving and displaying said text data on said bit map display;
at least one text region defined within said bit map display for displaying said text data; and
at least one graphic region within said bit map display for displaying said at least one graphical image retrieved from said memory.

30. A display system, comprising:
an up key;
a down key;
a command key;
a display device;
a memory;
an up key graphical image for storing in said memory;
a down key graphical image for storing in said memory;
a command key graphical image for storing in said memory;
a central processing unit in communication with said display device and said memory for displaying graphical images from said memory on said display device; and
a first executable function for determining if said up key, said down key, or said command key is active and for displaying said up key graphical image on said display device if said up key is active, and for displaying said down key graphical image on said display device if said down key is active, and for displaying said command key graphical image on said display device if said command key is active.
